(19) United States
(12) Patent Application Publication
(10) Pub. No.: US 2022/0014849 A1
(43) Pub. Date: Jan. 13, 2022

(54) EARPIECE, HEARING DEVICE AND SYSTEM FOR ACTIVE OCCLUSION CANCELLATION

(71) Applicant: GN Hearing A/S, Ballerup (DK)

(72) Inventor: Nikolaj CHRISTIANSEN, Valby (DK)

(73) Assignee: GN Hearing A/S, Ballerup (DK)

(21) Appl. No.: 17/348,538

(22) Filed: Jun. 15, 2021

(30) Foreign Application Priority Data
Jul. 10, 2020 (DK) PA202070474
Jun. 2, 2021 (EP) 21177283.5

(51) Int. Cl. H04R 3/02; H04R 1/10

(52) U.S. Cl. CPC H04R 3/02; H04R 1/1016; H04R 1/1083

(57) ABSTRACT

Disclosed is a system, a hearing device and an earpiece configured to be worn in an ear of a user. The earpiece comprising: a first input transducer configured for receiving sound from the ear canal of the user's ear, the first input transducer being configured for providing a first input transducer signal; an output transducer configured for providing sound to the ear canal, the output transducer being configured for providing an output transducer signal; a processing unit comprising an active occlusion cancellation algorithm configured to generate an output signal based on at least the first input transducer signal for providing active occlusion cancellation; wherein the earpiece further comprises: an acoustic filter configured for improving the active occlusion cancellation, the acoustic filter comprising: a vent channel for venting the ear canal, and an acoustic vent resonance cancelling filter implemented in the vent channel.

### RELATED APPLICATION DATA

This application claims priority to, and the benefit of, Danish Patent Application No. PA 2020 70474 filed on Jul. 10, 2020, and European Patent Application No. 21177283.5 filed on Jun. 2, 2021. The entire disclosures of the above applications are expressly incorporated by reference herein.

### FIELD

The present disclosure relates to a system, a hearing device and an earpiece configured to be worn in an ear of a user. The earpiece comprises a first input transducer configured for receiving sound from the ear canal of the user's ear. The first input transducer is configured for providing a first input transducer signal. The earpiece comprises an output transducer configured for providing sound to the ear canal. The output transducer is configured for providing an output transducer signal. The earpiece comprises a processing unit connected to the output transducer and the first input transducer. The processing unit comprises an active occlusion cancellation algorithm configured to generate the output transducer signal based on at least the first input transducer signal for providing active occlusion cancellation.

### BACKGROUND

Occlusion has for long been recognized as a problem for some hearing device users, such as hearing aid users, and continuous efforts have been made to reduce the occlusion effect.

Known solutions to reduce the occlusion effect provide a vent in the earpiece or earmold in order to allow pressure equalization between the ear canal and the surroundings.

Further, active occlusion cancellation (AOC) systems have been developed, the AOC systems having an ear canal microphone in the ear canal and being arranged along with the receiver at the tip of the earmold.

Despite the known solutions, there is still a need for improved occlusion cancellation, in particular in a hearing device.

### SUMMARY

Disclosed is an earpiece configured to be worn in an ear of a user. The earpiece comprises a first input transducer configured for receiving sound from the ear canal of the user's ear. The first input transducer is configured for providing a first input transducer signal. The earpiece comprises an output transducer configured for providing sound to the ear canal. The output transducer is configured for providing an output transducer signal. The earpiece comprises a processing unit connected to the output transducer and the first input transducer. The processing unit comprises an active occlusion cancellation (AOC) algorithm configured to generate the output transducer signal based on at least the first input transducer signal for providing active occlusion cancellation. The earpiece further comprises an acoustic filter configured for improving the active occlusion cancellation. The acoustic filter comprises a vent channel for venting the ear canal and is further configured as an acoustic high pass filter. The acoustic filter comprises an acoustic vent resonance cancelling filter (herein also called acoustic vent resonant cancelling filter) implemented in the vent channel. The acoustic filter is configured for improving the active occlusion cancellation by reducing low-frequency sound in the ear canal. The vent channel is configured to—at least indirectly—fluidly connect the ear canal with the environment and to operate as an acoustic low-pass filter, thereby reducing low-frequency sound in the ear canal. The acoustic vent resonance cancelling filter is configured to suppress a resonance of the vent channel.

The acoustic filter comprises a vent channel for venting the ear canal. The acoustic filter may further be configured as an acoustic high pass filter.

Some people wearing hearing devices, such as hearing aids, experience a strong occlusion effect, and these people may find that their own voice sounds disturbing, and they may also feel a sense of pressure or blockage in the ear when an earmold of a hearing device is inserted in the ear.

An occlusion effect occurs when some object, like an unvented earmold, completely fills the outer portion of the ear canal. This traps the bone-conducted sound vibrations of the person's own voice when speaking and movement/vibration induced sound from walking, running, chewing, etc. in the space between the tip of the earmold and the eardrum. Normally, when people talk or chew these vibrations escape through an open ear canal and the person is unaware of these sound vibrations. But when the ear canal is blocked by an earmold, the vibrations are reflected back toward the eardrum and increases the loudness perception of the person's own voice or movements. Compared to a completely open ear canal, the occlusion effect may boost the low frequency (usually below 500 Hz) sound pressure in the ear canal by 20 dB or more.

Active occlusion cancellation may be used to reduce or remove the occlusion effect for the user of an earpiece or a hearing device.

Active occlusion cancellation is a method for reducing unwanted sound by the addition of a second sound specifically designed to cancel the first. This may also be used in active noise control (ANC), also known as noise cancellation, or active noise reduction (ANR).

Sound is a pressure wave, which consists of alternating periods of compression and rarefaction. An output transducer (e.g. a receiver or speaker) in an earpiece performing active occlusion cancellation emits a sound wave with the same amplitude but with inverted phase (also known as antiphase) to the original sound. The waves combine to form a new wave, in a process called interference, and effectively cancel each other out—an effect that is called destructive interference.

Active occlusion cancellation may be achieved through the use of analog circuits or digital signal processing. Adaptive algorithms are designed to analyze the waveform of the original sound, i.e. the sound received in an input transducer in the ear (e.g. an ear canal microphone and/or a bone conduction unit), and then based on the specific algorithm generate a signal of equal amplitude with either shifted phase or invert the polarity of the original signal. This inverted signal (in antiphase) may then be amplified and the output transducer in the ear creates a sound wave directly proportional to the amplitude of the original waveform, creating destructive interference. This effectively reduces the volume of the perceivable occlusion effect. Typically, the analog circuits or digital signal processing may further be configured to prevent or reduce cancelling of a desired audio signal provided to the output transducer. The desired audio signal may e.g. be based on a sound signal received from the environment by a microphone and further processed to compensate a hearing loss of the user and/or on an audio signal received from another device for playback to the user.

The output transducer emitting the cancellation signal is located at the location where sound attenuation is wanted, i.e. in the users ear.

Very high sound pressure levels (SPL) can be generated in an occluded ear canal due to own voice as well as subsonic frequencies generated by jaw motion. Subsonic energy levels may reach as high as 140-145 dB SPL at 2 Hz in an occluded canal. This is an important consideration when dealing with Active Occlusion Cancelation (AOC) because such high low frequency output levels could overdrive the output transducer (receiver) and/or saturate the first input transducer (ear canal microphone).

To mitigate this problem, an acoustical filter can be introduced to the system. The term “main sound path” designates the acoustic path from the output transducer to the eardrum of the user and/or to the first input transducer. Filtration of sound may be obtained by introducing an impedance mismatch, either by a change in the size and/or shape of the main sound path and/or by implementing a side branch channel to the main sound path, which partly reflects undesirable frequencies, as determined by the size and shape of the variation of the main sound path and/or the side branch channel. A (serial) channel of altering cross-sectional areas, such as one or more wider or narrower cross-sectional areas in the output sound channel in the earpiece, will function as a low-pass filter, by reflecting high frequencies. Wherein the cross-sectional area(s) is cross-sectional area(s) perpendicular to the center axis/line of the output sound channel. While an opening/side branch or series of openings/side branches, such as one or more openings or side branch channels in the sidewall of the output sound channel in the earpiece, will function as a high-pass filter, removing low frequencies. As an example, the vent channel may—while in itself functioning as a low-pass filter—provide an acoustic high pass filter effect to the main sound path by being implemented as an open-ended tube or channel in a side branch configuration to the main sound path. Due to the nature of low frequencies the side configuration to the main sound path, i.e. the side channel branch or side tube branch, may be placed anywhere along the main sound path.

A vent of e.g. 1 mm diameter and about 2 cm length may reduce the energy level of own voice and/or subsonic frequencies considerably such that they may be managed. The energy level at the eardrum and/or at the input transducer may in this example, starting from 140-145 dB SPL at 2 Hz in an occluded canal, be reduced by about 45 dB and/or to approximately 95-100 dB.

However, the usefulness of having a vent comes at a cost as it can increase the amount of audible occlusion due to the introduction of a vent resonance at frequencies in the active occlusion cancellation (AOC) range of a typical active occlusion cancellation (AOC) algorithm. The vent resonance may be at frequencies within the range of 100-2000 Hz, such as 150-250 Hz, such as about 200 Hz, such as 1400-1600 Hz, such as about 1500 Hz. Furthermore, the aggressive roll-off below the vent resonance reaches into the typical AOC frequency range of about 80 Hz to 600 Hz, which inflicts greatly on the performance of the typical AOC algorithm due to drastic changes in phase that the typical AOC algorithm cannot handle.

The present disclosure concerns solving the problems that the vent introduces, while keeping the benefits of the vent. In some embodiments, the problem may be solved by providing an acoustic filter in the earpiece. The resulting/combined acoustic filter comprises a vent channel for venting the ear canal and is further configured as an acoustic high pass filter, with an acoustic vent resonant cancelling filter implemented in the vent channel.

In some embodiments, the problem of the high subsonic sound pressure levels may be solved by configuring the vent channel to cause the main sound path to exhibit an acoustic high pass filter effect. Additionally, the problem which the vent introduces may be solved by insertion of an acoustic vent resonant cancelling filter, such as a foam or mesh material, in the vent to increase the acoustic mass/resistance of the vent. This may provide the same effect as making the vent significantly longer and/or narrower, but without the size penalty that comes with these corrections, which is perfect for small earpieces or small in-the-ear hearing devices. Thus, it is an advantage that the vent channel configured to cause the main sound path to exhibit an acoustic high pass filter effect together with the acoustic vent resonant cancelling filter provides an acoustic filter, i.e. a resulting/combined acoustic filter. The acoustic filter is configured for improving the active occlusion cancellation relative to a normally vented device.

The improved vent channel may not in itself act as a “high-pass” filter. Instead, it may act as a low-pass filter that releases low-frequency sound from the ear canal to the surroundings. Thereby, the entire acoustic path from the receiver to the eardrum—including the vent—may act as an acoustic high-pass filter to provide the desired effect.

The terms “vent resonant cancelling filter” and “vent resonance cancelling filter” may be used interchangeably throughout the description. This filter may not be resonant in itself. This filter may be designed to “cancel” or suppress or smoothen or annulling a resonance in the vent.

Thus, jaw movements may induce subsonic sound at about 2 Hz, and an open vent may reduce subsonic sounds at the cost of introducing a “vent resonance” in the range from 150 Hz to 350 Hz that may negatively influence the AOC over its entire frequency range of about 80 Hz to 600 Hz.

Thus, it is an advantage to reduce the influence by the vent resonance on AOC performance.

The above advantage/feature may be achieved by provision of a vent resonance cancelling filter which may be an acoustic resistive material placed in the vent to increase loss at the vent resonance and further move the vent resonance downwards in frequency.

The high pass cut-off frequency of the acoustic high pass filter configuration will depend on shape and size of the vent channel and the properties of the acoustic vent resonant cancelling filter. The acoustic high pass filter configuration may for example be configured to have a cut-off frequency of 100 Hz or lower than 100 Hz.

As an example (see details in figure description), the frequency response of a simulated earpiece with a vent being 22 mm long and 0.8 mm in diameter, with an acoustic vent resonant cancelling filter being an acoustic mesh filter of 60 Rayls (Pa*s/m) has been provided. It has been shown how the acoustic vent resonant cancelling filter smoothens the vent resonance and pushes the low-frequency roll off closer to the 80-100 Hz target that may be required in order to avoid drastic phase changes in the AOC range, which is between 80-600 Hz, while still providing a noticeable roll-off toward low frequencies to avoid high own voice and/or subsonic energy levels.

Thus, it is an advantage that the acoustic vent resonant cancelling filter may be an absorptive component that will dampen the sound over the whole frequency spectrum. The vent channel may be a reactive component that causes the main sound path to exhibit an acoustic high pass filter effect, hence the low frequency roll-off, i.e. the low frequencies do not pass. When a resistive acoustic vent resonant cancelling filter is combined with a reactive (inductive) vent, they create a certain type of acoustic filter with the right properties that provides the desired solution.

The average occlusion effect is about 15 dB amplification of low frequencies below 500 Hz, such as between 100-400 Hz, with peaks up to 30 dB. When simulating active occlusion cancellation (AOC) performance in the earpiece, the vented device without the acoustic vent resonant cancelling filter may only give a very slight reduction in occlusion, such as 2-4 dB or about 3 dB at 145-160 Hz, such as about 150 Hz, in a very narrow bandwidth of dampening. By introducing the acoustic vent resonant cancelling filter in the vent, the simulated AOC performance may reach +15 dB dampening, which is equal to or approximately equal to the unvented configuration and which may have a very wide bandwidth that is almost identical to the unvented earpiece and with less low frequency overshoot than the unvented configuration.

By implementing an acoustic vent resonant cancelling filter in the vent channel, wherein the acoustic vent resonant cancelling filter may be an absorptive component that dampens the sound over the whole frequency spectrum and the vent channel is a reactive component that, in this particular configuration, causes the main sound path to exhibit an acoustic high pass filter effect, hence the low frequency roll-off (i.e. the low frequencies does not enter/pass the vent channel), a certain type of acoustic filter is obtained with the right properties, i.e. a good AOC performance like that of an unvented device, while still maintaining the necessary properties of the vent for the AOC algorithm and/or AOC system to work properly.

Thus, a vent may be necessary for a typical AOC algorithm to work in all conditions, however it comes at the cost of lost performance. Thus, it is an advantage of the present earpiece/hearing device/hearing protection device/hearing aid that the vent channel with the acoustic vent resonant cancelling filter results in a good AOC performance like that of an unvented device, while still maintaining the necessary properties of the vent for the AOC algorithm and/or AOC system to work properly. Thus, it is an advantage that the earpiece comprises an acoustic filter configured for improving the active occlusion cancellation, because the acoustic filter comprises a vent channel for venting the ear canal and configured to cause the main sound path to exhibit an acoustic high pass filter effect, and because the acoustic filter further comprises a acoustic vent resonant cancelling filter implemented in the vent channel. It is an advantage that the vent channel together with the acoustic vent resonant cancelling filter provides an acoustic filter.

The earpiece is configured to be worn in an ear of a user. The earpiece may be an earpiece for a hearing device. The earpiece may be an earmold. The earpiece may be a hearing device. The earpiece or hearing device may be one of a pair of earpieces or hearing devices. The hearing device or earpiece may be a device that occludes the ear canal, such as a receiver-in-ear (RIE), receiver-in-canal (RIC), completely-in-canal (CIC), in-the-ear (ITE) device. The hearing device or earpiece may be an earbud, a headset, a hearing aid, a hearing protection device, such as a passive or active hearing protection etc. The earpiece or hearing device may be a binaural hearing aid, an in-the-ear (ITE) hearing aid, an in-the-canal (ITC) hearing aid, a completely-in-the-canal (CIC) hearing aid, a behind-the-ear (BTE) hearing aid, a receiver-in-the-canal (RIC) hearing aid etc. The earpiece or hearing device may be a digital hearing device. The earpiece or hearing device may be a hands-free mobile communication device, a speech recognition device etc. The earpiece or hearing device or hearing aid may be configured for or comprise a processing unit configured for compensating a hearing loss of a user of the earpiece or hearing device or hearing aid.

The earpiece may have a first end pointing towards the ear canal/tympanic membrane. The earpiece may have a second end pointing towards the surroundings.

The earpiece comprises a first input transducer configured for receiving sound from the ear canal of the user's ear. The first input transducer may be a microphone, such as an ear canal microphone/in-ear microphone/in-canal microphone, a bone conduction unit etc. The first input transducer is arranged in the first end of the earpiece pointing towards the ear canal/tympanic membrane. The first input transducer may be connected to a first input transducer opening in the first end of the earpiece.

The first input transducer is configured for receiving sound from the ear canal of the user's ear. The sound from the ear canal may e.g. be noise comprising the user's own voice and/or subsonic frequencies generated by jaw movement. The sound may be movement/vibration induced sound from the user walking, running, chewing etc. The first input transducer is configured for providing a first input transducer signal.

The first input transducer may be an ear canal microphone. The first input transducer may have a sound inlet positioned at a tip portion of the earpiece, such as in a tip portion of a ITE, ITC or CIC hearing aid housing or at a tip of the earplug or earmold of the headset, hearing protection device or BTE hearing aid. The sound inlet preferably allowing unhindered sensing of the ear canal sound pressure within a fully or partly occluded ear canal volume residing in front of the users tympanic membrane or eardrum, i.e. allowing that the first input transducer signal is received unhindered.

The first input transducer is configured for receiving sound from the ear canal of the user's ear, which may be a body-conducted voice signal and/or which may be a bone-conducted signal and/or which may be a low frequency signal. The body-conducted voice signal may not be a bone-conducted signal, such as a pure bone-conducted signal. The body-conducted voice signal is to be received in the ear canal of the user of the earpiece by the first input transducer. The body-conducted voice signal is transmitted through the body of the user from the mouth and throat of the user where the voice or speech is generated. The body-conducted voice signal is transmitted through the body of the user by the user's bones, bony-structures, cartilage, soft-tissue, tissue and/or skin. The body-conducted voice signal is transmitted at least partly through the material of the body, and the body-conducted voice signal may thus be at least partly a vibration signal. As there may also be air cavities in the body of the user, the body-conducted voice signal may also be at least a partly air-transmitted signal, and the body-conducted voice signal may thus be at least partly an acoustic signal.

The earpiece comprises an output transducer configured for providing sound to the ear canal. The output transducer is configured for providing an output transducer signal. The output transducer may be a receiver, a speaker, a loudspeaker etc. The output transducer may be arranged in the first end of earpiece pointing towards the ear canal/tympanic membrane. The output transducer may be connected to an output transducer opening in the first end of the earpiece. The output transducer may have a sound outlet positioned at a tip portion of the earpiece, such as in a tip portion of a ITE, ITC or CIC hearing aid housing or at a tip of the earplug or earmold of a headset, hearing protection device or BTE hearing aid. The sound outlet preferably allowing that the output transducer signal is provided unhindered to the ear canal.

The earpiece comprises a processing unit connected to the output transducer and the first input transducer. The processing unit comprises an active occlusion cancellation algorithm or an active occlusion cancellation unit configured to generate the output transducer signal based on at least the first input transducer signal for providing active occlusion cancellation.

Thus, the processing unit comprising the active occlusion cancellation algorithm or unit receives the first input transducer signal, processes the first input transducer signal, provides a cancelling signal to the output transducer, wherein the output transducer provides the output transducer signal comprising the cancelling signal.

More input signals may be provided to the processing unit, e.g. a second input transducer signal from a second input transducer arranged in the second end of the earpiece, where the second end of the earpiece is pointing towards the surroundings. This may be the case if the earpiece is a/for a hearing aid for compensating a hearing loss of the user. In this case, the processing unit comprising the active occlusion cancellation algorithm or unit may receive at least the first input transducer signal, processes at least the first input transducer signal, provide a cancelling signal to the output transducer, wherein the output transducer provides the output transducer signal comprising the cancelling signal. Thus, the processing unit comprising the active occlusion cancellation algorithm or unit may receive the first input transducer signal and the second input transducer signal, processes the first input transducer signal and the second input transducer signal, provide a cancelling signal to the output transducer, wherein the output transducer provides the output transducer signal comprising the cancelling signal. The processing unit comprising the active occlusion cancellation algorithm or unit may further comprise a hearing compensation algorithm or hearing compensation unit, wherein the first input transducer signal is processed by using the active occlusion cancellation algorithm or unit and the second input transducer signal is processed by using the hearing compensation algorithm or unit.

The processing unit comprises an active occlusion cancellation algorithm or unit configured to generate the output transducer signal based on at least the first input transducer signal for providing active occlusion cancellation. The output transducer signal from the output transducer may be specifically designed/processed/generated to cancel the first input transducer signal. This provides the active occlusion cancellation. The output transducer signal may be a sound wave with the same amplitude but with inverted phase (also known as antiphase) to the first input transducer signal. The sound wave of the output transducer signal may be a sound wave in antiphase with the first input transducer signal. Thus, the output transducer signal may be an inverse sound or opposite phase to the first input transducer signal. The sound waves are combined to form a new wave wherein the waves effectively cancel each other out, which is called destructive interference.

The active occlusion cancellation algorithm may comprise or may be an active occlusion cancellation unit in the processing unit. The active occlusion cancellation algorithm may be a finite sequence of well-defined, computer-implementable instructions, to perform a computation of active occlusion cancellation of the occlusion signal, i.e. parts of the first input transducer signal. The active occlusion cancellation algorithm may be used as a specification for performing calculations and data processing of the sound signals, i.e. the first input transducer signal(s).

The earpiece further comprises an acoustic filter configured for improving the active occlusion cancellation. The acoustic filter comprises a vent channel for venting the ear canal and configured to cause the main sound path to exhibit an acoustic high pass filter effect. The acoustic filter comprises a acoustic vent resonant cancelling filter implemented in the vent channel. Thus, the earpiece comprises a vent channel for venting the ear canal. The vent channel is configured to cause the main sound path to exhibit an acoustic high pass filter effect to remedy subsonic occlusion/pressure build-up. The vent channel comprises an acoustic vent resonant cancelling filter. The combination of the vent channel and the acoustic vent resonant cancelling filter provides the acoustic filter. Alternatively, the earpiece may comprise a vent channel for venting the ear canal, wherein the vent channel comprises an acoustic filter configured for improving the active occlusion cancellation.

Thus, the earpiece further comprises a vent channel for venting the ear canal. The vent channel is for venting the ear canal, i.e. for reducing the sound pressure in the ear canal. The vent channel may have a first vent opening in the first end of the earpiece i.e. at the ear canal. The vent channel may have a second vent opening in the second end of the earpiece, i.e. towards the surroundings.

The vent channel may have a length of about 22 mm. The vent channel may have a diameter of about 0.8 mm.

However, the dimensions of the vent channel may vary. The size of the vent channel (in combination with the filter) may be designed to shape the frequency response as desired. The length of the vent channel may thus be in the range between 0.1-3 cm. The diameter of the vent channel may thus be in the range from 0.5-2 mm.

The vent channel may be a short vent channel, such as less than 2 cm long, such as less than 1 cm long, such as less than 0.5 cm long, or such as less than 0.25 cm long. The short vent channel may have a first end pointing towards the tympanic membrane in the ear canal of the user and a second end pointing towards the surroundings, when the earpiece is worn in its intended operational position. The short vent channel may exit the earpiece towards the surroundings in a side wall of the first end of the earpiece and/or the tip portion of the earpiece. Thus, the second end of the short vent channel may be in the first end of the earpiece. The thickness of the side wall may correspond to/be the same as the length of the short vent channel. The thickness of the side wall and/or the length of the short vent channel may be about 0.5-1 mm.

The vent channel protects the first input transducer from saturation. The vent channel protects the output transducer from being overdriven. Hereby, the vent channel ensures that the first input transducer signal is interpretable to the processing unit (DSP), and that the output transducer is capable of playing/providing/outputting what it is instructed to play by the processing unit. This as, the first input transducer signal may not be so loud that the output transducer cannot deliver the required cancellation signal. Thus, the purpose may be to only trying to cancel parts of the input signal, namely the occlusion part.

The vent channel or short vent channel comprises an acoustic vent resonant cancelling filter configured for improving the active occlusion cancellation. The acoustic vent resonant cancelling filter may be a physical filter, a mechanical filter etc. The acoustic vent resonant cancelling filter may be made of foam, mesh, cloth, textile, fabric, plastic, metal and/or metal alloy.

The terms “vent resonant cancelling filter” and “vent resonance cancelling filter” may be used interchangeably throughout the description. This filter may not be resonant in itself. This filter may be designed to “cancel” or suppress or smoothen or annulling a resonance in the vent.

It is an advantage that the acoustic vent resonant cancelling filter in the vent channel provides that the acoustic mass/acoustic resistance of the vent channel is increased.

It is an advantage that the vent channel together with the acoustic vent resonant cancelling filter provides an acoustic filter.

It is an advantage that this acoustic filter smoothens the vent resonance and pushes the low-frequency roll off below the 80-100 Hz target that may be required in order to avoid drastic phase changes in the AOC range, which is between 80-600 Hz, while still providing a noticeable roll-off toward low frequencies to avoid high subsonic energy levels.

It is an advantage that the acoustic vent resonant cancelling filter in the vent channel provides that the AOC performance may reach +15 dB dampening, which is equal to or approximately equal to the unvented configuration and which may have a very wide bandwidth that is almost identical to the unvented earpiece, which is also preferred.

It is an advantage that the acoustic vent resonant cancelling filter in the vent channel results in a good AOC performance like that of an unvented device, while still maintaining the necessary properties of the vent for AOC to work properly.

The processing unit may be adapted to receive and process the first input transducer signal in accordance with a predetermined or adaptive processing scheme for generating a processed output signal. The output transducer may be adapted to receive and convert the processed output signal into a corresponding acoustic signal, i.e. an output transducer signal, to produce ear canal sound pressure in a user's ear canal. The first input transducer may be configured to receive and to convert the ear canal sound pressure into an electronic ear canal signal provided to the processing unit.

The earpiece may be for a head-wearable hearing device that may comprise different types of head-worn listening or communication devices such as a headset, hearing protection device or hearing instrument or hearing aid. The hearing device, such as a hearing aid, may be embodied as an in-the-ear (ITE), in-the-canal (ITC), or completely-in-the-canal (CIC) device with a housing, shell or housing portion shaped and sized to fit into the users ear canal. The housing or shell may enclose a second input transducer, which may be an ambient microphone, the processing unit, the first input transducer and the output transducer. Alternatively, the earpiece may be for a hearing device, such as a hearing aid, embodied as a receiver-in-the-ear (RIC) or traditional behind-the-ear (BTE) device comprising the earpiece, such as an earmold or earplug for insertion into the users ear canal. A BTE hearing device may comprise a flexible sound tube adapted for transmitting sound pressure generated by a transducer placed within a housing of the BTE hearing device to the users ear canal. In this embodiment, the first input transducer may be arranged in the earpiece while the second input transducer, the processing unit and the output transducer are located inside the BTE hearing device housing. The ear canal signal may be transmitted to the processing unit through a suitable electrical cable or another wired or unwired communication channel. The second input transducer may be positioned inside the housing of the head-worn hearing device. The second input transducer may sense or detect the surrounding sound, environmental sound or ambient sound through a suitable sound channel, port or aperture extending through the housing of the head-worn hearing device.

Also disclosed is a system for an earpiece, the earpiece being configured to be worn in an ear of a user. The system comprising:

a first input transducer configured for receiving sound from the ear canal of the user's ear, the first input transducer being configured for providing a first input transducer signal;

an output transducer configured for providing sound to the ear canal, the output transducer being configured for providing an output transducer signal;

a processing unit connected to the output transducer and the first input transducer, the processing unit comprises an active occlusion cancellation algorithm configured to generate the output transducer signal based on at least the first input transducer signal for providing active occlusion cancellation;

wherein the system further comprises:

an acoustic filter configured for improving the active occlusion cancellation, the acoustic filter comprising:

a vent channel for venting the ear canal and configured to cause the main sound path to exhibit an acoustic high pass filter effect, and

an acoustic vent resonant cancelling filter implemented in the vent channel.

The acoustic filter comprises a vent channel for venting the ear canal. The acoustic filter may be configured to cause the main sound path to exhibit an acoustic high pass filter effect. The system may be an active occlusion cancelling (AOC) system.

Also disclosed is a hearing device, the hearing device being configured to be worn in an ear of a user. The hearing device comprising:

a first input transducer configured for receiving sound from the ear canal of the user's ear, the first input transducer being configured for providing a first input transducer signal;

an output transducer configured for providing sound to the ear canal, the output transducer being configured for providing an output transducer signal;

a processing unit connected to the output transducer and the first input transducer, the processing unit comprises an active occlusion cancellation algorithm or an active occlusion cancellation unit configured to generate the output transducer signal based on at least the first input transducer signal for providing active occlusion cancellation;

wherein the hearing device further comprises:

an acoustic filter configured for improving the active occlusion cancellation, the acoustic filter comprising:

a vent channel for venting the ear canal and configured to cause the main sound path to exhibit an acoustic high pass filter effect, and

an acoustic vent resonant cancelling filter implemented in the vent channel.

The acoustic filter comprises a vent channel for venting the ear canal. The acoustic filter may be configured to cause the main sound path to exhibit an acoustic high pass filter effect.

In some embodiments, the acoustic vent resonant cancelling filter is configured for providing an increased acoustic resistance of the vent channel. This is an advantage because the increased acoustic resistance/acoustic mass provides that the frequency magnitude response is flat, i.e. has no top (local maxima), and rolls off nicely at frequencies below 80-100 Hz. Thus, the increased acoustic resistance provides a flat frequency response in the relevant frequencies above 80 Hz to yield optimal working conditions for the AOC algorithm and ensures the sound pressure level rolls off nicely, i.e. not too fast nor slow, at frequencies lower than this to protect the transducers.

In some embodiments, the acoustic filter is configured for optimizing the output transducer signal generated by the active occlusion cancellation algorithm or unit.

The acoustic vent resonant cancelling filter of the acoustic filter ensures a flat frequency response, by annulling the vent resonance, until the low frequency roll-off of the vent kicks in to protect the first input transducer and/or the output transducer. The flat frequency response will improve the AOC performance relative to a vent channel without an acoustic vent resonant cancelling filter, but similar to an unvented device, which runs the risk of damaged input/output transducers. The acoustic filter provides smoothing of the frequency resonance of the vent channel and pushes the low-frequency roll off closer to a 40-100 Hz , such as a 50-80 Hz, target that is preferred in order to avoid drastic phase changes in the active occlusion cancellation (AOC) range, which is between 80-600 Hz, while still providing a noticeable roll-off toward low frequencies to avoid high subsonic energy levels.

In some embodiments, the vent channel provides reduction of the subsonic/low-frequency sound pressure levels in the ear canal of the user. It is an advantage that the vent channel provides a reduction in low frequency sound pressure. The vent channel let out some of the sound pressure from the ear canal.

In some embodiments, the acoustic vent resonant cancelling filter provides a changed/smoothed frequency response of the vent channel. It is an advantage that the acoustic vent resonant cancelling filter smoothens the vent resonance and pushes the low-frequency roll off closer to the 80-100 Hz target that may be required in order to avoid drastic phase changes in the AOC range, which is between 80-600 Hz, while still providing a noticeable roll-off toward low frequencies to avoid high subsonic energy levels.

In some embodiments, the acoustic vent resonant cancelling filter is a physical filter or a mechanical filter. Thus, the acoustic vent resonant cancelling filter is a physical/mechanical filter that can be inserted/implemented in the vent channel. The acoustic vent resonant cancelling filter is an absorptive component that will dampen the sound over the whole frequency spectrum. The vent is a reactive component that, in this particular configuration, acts to cause the main sound path to exhibit an acoustic high pass filter effect, hence the low frequency roll-off, i.e. the low frequencies do not pass. When the resistive acoustic vent resonant cancelling filter is combined with the reactive (inductive) vent, they create a certain type of acoustic filter with the right properties that provides the desired solution.

In some embodiments, the acoustic vent resonant cancelling filter is made of foam, mesh, plastic, cloth, textile, fabric, metal alloy and/or metal. The acoustic vent resonant cancelling filter may be made of a woven grid of textile. The acoustic vent resonant cancelling filter may be a membrane. The acoustic vent resonant cancelling filter may comprise monofilament fibers. The acoustic vent resonant cancelling filter may have a pore size in the range of 15-300 micrometer (μm). The acoustic vent resonant cancelling filter may have a thickness in the range of 30-300 micrometer (μm).

In some embodiments, the acoustic vent resonant cancelling filter comprises/is defined by an acoustic impedance value. Acoustic impedance is defined as the ratio of acoustic pressure to acoustic volume flow and has the unit Pa*s/m3, also called Rayls per m\hat{ }2. The specific acoustic impedance is a ratio of acoustic pressure to specific flow, which is the same as flow per unit area, or acoustic volume velocity and it has the unit of Pa*s/m or simply Rayls. As such, specific acoustic impedance describes the density and dampening parameters of a porous media which determines the resulting pressure when a sound wave with a given volume velocity travels through it, unscaled by the cross-section area of the media itself. The resulting pressure will scale with the cross-section area of the given filter (media) if acoustic impedance parameters are utilized instead of specific acoustic impedance.

In some embodiments, the acoustic vent resonant cancelling filter has a specific acoustic impedance value in the range of 10-500 Rayls (Pa*s/m), such as 60 Rayls (Pa*s/m). Thus, the acoustic impedance value may be in the range of 10-400 Rayls (Pa*s/m), or in the range of 10-300 Rayls (Pa*s/m), or in the range of 10-200 Rayls (Pa*s/m), or in the range of 10-100 Rayls (Pa*s/m), or in the range of 10-80 Rayls (Pa*s/m), or in the range of 20-70 Rayls (Pa*s/m), or in the range of 30-65 Rayls (Pa*s/m), or in the range of 35-65 Rayls (Pa*s/m). Thus, the acoustic impedance value may be about 35 Rayls (Pa*s/m), or 40 Rayls (Pa*s/m), or about 45 Rayls (Pa*s/m), or about 50 Rayls (Pa*s/m), or about 55 Rayls (Pa*s/m), or about 60 Rayls (Pa*s/m), or about 65 Rayls (Pa*s/m).

In some embodiments, the acoustic vent resonant cancelling filter comprises/is defined by a surface size and/or a density.

In some embodiments, the vent channel has a first end and/or first end opening pointing towards the tympanic membrane in the ear of the user and a second end and/or second end opening pointing towards the surroundings, when the earpiece is worn in its intended operational position. In some embodiments, the acoustic vent resonant cancelling filter is arranged in the second end and/or second end opening of the vent channel. However, the acoustic vent resonant cancelling filter can be located anywhere in the vent channel, as the location of the acoustic vent resonant cancelling filter in the vent channel may not matter in terms of performance. In some embodiments, the acoustic vent resonant cancelling filter is arranged in the first end and/or first end opening of the vent channel. In some embodiments, the acoustic vent resonant cancelling filter is arranged in the centre of the vent channel.

It is an advantage that the acoustic vent resonant cancelling filter is arranged in the second end and/or second end opening or first end and/or first end opening of the vent channel, as it may be easier to arrange the acoustic vent resonant cancelling filter in one of the ends of the vent channel, instead of in the centre of the vent channel. Furthermore, it may be an advantage to arrange the acoustic vent resonant cancelling filter in the second end of the vent channel when the acoustic vent resonant cancelling filter is further configured for providing protection against water and dirt, as the second end of the vent channel is towards the surroundings where water and dirt typically comes from.

In some embodiments, the acoustic vent resonant cancelling filter is further configured for providing protection against water and dirt. It is an advantage that the acoustic vent resonant cancelling filter also protects against water and dirt. It is an advantage when the acoustic vent resonant cancelling filter is arranged in the second end and/or second end opening of the vent channel as this is towards the surroundings where water and dirt typically comes from. The acoustic vent resonant cancelling filter may be hydrophobic, thereby be repellent towards water and dirt.

In some embodiments, the acoustic vent resonant cancelling filter is arranged in a frame, and wherein the frame is configured to be pushed/slid into the vent channel for fixation of the acoustic vent resonant cancelling filter in the vent channel or placed/arranged to cover the first or second end opening.

In some embodiments, the earpiece forms part of a hearing device. The earpiece may be a receiver-in-ear (RIE) part of a hearing aid, it may be an earpiece for a behind-the-ear (BTE), the earpiece may be an in-the-ear (ITE), it may be an earbud, an earpiece for a headset, an earpiece for any hearing aid etc. The hearing device may have a first end towards the ear canal/tympanic membrane, and a second end towards the surroundings.

In some embodiments, the earpiece further comprises a second input transducer configured for receiving sound from the surroundings, wherein the second input transducer is connected to the processing unit. The second input transducer may be arranged in the second end of the earpiece or hearing device, which is the end pointing towards the surroundings. The second input transducer may be a microphone, such as a directional or omni-directional microphone or input transducer. The second input transducer may receive sound from the surroundings that are processed in the processing unit and outputted in the user's ear via the output transducer. If the earpiece is a/for a hearing aid, then the processing unit may process the sound from the second input transducer for compensating a hearing loss of the user. The second input transducer is configured to be arranged outside the ear canal of the user, and the second input transducer may be configured to detect sounds from the surroundings of the user. The second input transducer may point in any direction and thus may pick up sounds coming from any direction. The second input transducer may be arranged outside of the earpiece. The second input transducer may for example be arranged in a faceplate of a hearing device, for example for a completely-in-the-canal (CIC) hearing device and/or for an in-the-ear (ITE) hearing device. The second input transducer may for example be arranged behind the ear of the user for a behind-the-ear (BTE) hearing device and/or for a receiver-in-the-canal (RIC) hearing device.

The second input transducer is configured for generating a second input transducer signal. The second input transducer is connected to the processing unit for providing the second input transducer signal to the processing unit.

The processing unit comprising the active occlusion cancellation algorithm or unit configured to generate the output transducer signal may be based on both the first input transducer signal and the second input transducer signal for providing active occlusion cancellation and/or active noise cancellation.

In some embodiments, the earpiece is a noise cancellation device configured for noise cancellation of surrounding sounds. In this case, the earpiece may also comprise a second input transducer capturing sounds from the surroundings.

In some embodiments, the earpiece is for a hearing aid configured to compensate for a hearing loss of the user. Thus, the processing unit may process the sound from the second input transducer and/or from the first input transducer for compensating a hearing loss of the user. The processing unit comprising the active occlusion cancellation algorithm or unit may further comprise a hearing compensation algorithm or hearing compensation unit. The sound from the second input transducer may be processed by using the hearing compensation algorithm or unit. The output from the active occlusion cancellation algorithm or unit and the hearing compensation algorithm or unit may be added in an adder for providing the output transducer signal comprising active occlusion cancellation.

In some embodiments, the earpiece is for a headset configured for transmission of audio to the user's ear. Thus, the headset may be used for listening to audio, such as music, and/or for having phone calls with end-far callers.

The earpiece may be/have an earmold having an earmold shell. The earmold shell may have an outer surface. The outer surface may be configured to fit at the concha of the ear and/or into the ear canal of a user of the earpiece.

The earpiece may extend along an axis. The axis may be parallel to the longitudinal direction of the earpiece. The axis may be substantially parallel with the ear canal axis, i.e. within 2-5 degrees.

The earpiece may have a first end, being a tip end (distal end) with a tip surface facing a tympanic membrane of the user when the earpiece is worn by the user. The axis may be perpendicular to or substantially perpendicular to the tip surface. The tip surface may be plane or rounded. Further, the earpiece may have a second end being a proximal end. The earpiece may have a proximal surface facing away from the tympanic membrane when the earpiece is worn by the user.

The earpiece comprises a first input transducer, which may be an ear canal microphone, connected to a first input transducer opening for receiving sound from/in the ear canal. The first input transducer acting as an ear canal microphone may be connected to the first input transducer opening via a first input transducer duct formed by a first input transducer tube and/or a first input transducer channel in the earpiece/earmold shell/housing. The first input transducer opening may be perpendicular to the ear canal axis or angled e.g. with an angle in the range from 70 degrees to 110 degrees, thus pointing into the ear canal of a user.

The first input transducer opening may be arranged in a first position at a first distance from the tip end (measured along the axis). The first distance may be in the range from 0 to 8 mm or larger. The first input transducer opening may be arranged near or at the tip end. For example, the first distance may be less than 2 mm. The first input transducer opening may be arranged between the tip end and the proximal end of the earmold. The first input transducer opening may be arranged between the tip end and the tympanic membrane. The first input transducer opening may have a diameter of at least 0.5 mm

The earpiece may comprise an output transducer opening. The earpiece may comprise an output transducer connected to the output transducer opening for producing sound in the ear canal. The output transducer may be connected to the output transducer opening via an output transducer duct formed by an output transducer tube and/or an output transducer channel in the earmold shell. The output transducer opening may be perpendicular to the ear canal axis or angled e.g. with an angle in the range from 70 degrees to 110 degrees, thus pointing into the ear canal of a user.

The output transducer opening may be arranged in a second position at a second distance from the tip end (measured along the axis). The second distance may be in the range from 0 to 8 mm or larger.

The first input transducer opening and the output transducer opening may be connected, e.g. such that the first input transducer opening and the output transducer opening coincides, e.g. in the transverse plane perpendicular to the ear canal axis. A sound inlet of the first input transducer, the first end of the vent channel and an outlet of the output transducer may coincide in a first opening of the earpiece. A tip component may be arranged at the first opening of the earpiece. The tip component may be dome shaped and may be made of foam or flexible plastic material.

Alternatively, the first input transducer opening and the output transducer opening may be separated in a transverse plane perpendicular to the ear canal axis, e.g. such that the first input transducer opening and the output transducer opening do not coincide in the transverse plane. The output transducer opening may have a diameter of at least 0.5 mm.

The earpiece may comprise a vent channel with a vent opening for venting the ear canal. The first input transducer opening and the vent opening may be connected, e.g. such that the first input transducer opening and the vent opening coincides. The vent opening may have a diameter of at least 0.5 mm. Alternatively, the first input transducer opening and the vent opening may be separated in a transverse plane perpendicular to the ear canal axis such that the first input transducer opening and the vent opening do not coincide. The vent opening may have a diameter of at least 0.5 mm.

The vent channel may be straight. The vent channel may be bended, such as having one of more bend between its first end and second end.

The hearing device may be a headset or earbud(s) for audio communication. The hearing device may be a hearing protection device for protection of e.g. loud/impulse sounds. The hearing device may be a hearing aid for compensating for a hearing loss of the user. The hearing aid may be any hearing aid, such as a hearing aid of the in-the-ear type, such as in-the-canal type, such as completely-in-the-canal type of hearing aid, etc., a hearing aid of the receiver-in-the-ear type of hearing aid, etc.

The hearing device may comprise one or more input transducers configured for converting an acoustic sound signal from a sound source into an audio signal. The audio signal is configured to be processed in the processing unit for compensation of a hearing loss of the user. The processed audio signal is configured to be converted into a processed acoustic signal by the output transducer.

The hearing device may be a binaural hearing device. The hearing device may be a first hearing device and/or a second hearing device of a binaural hearing device.

The hearing device may be a device configured for communication with one or more other device, such as configured for communication with another hearing device or with an accessory device or with a peripheral device.

The present disclosure relates to different aspects including the earpiece described above and in the following, and corresponding earpieces, earmolds, hearing devices, systems, methods, networks, kits, uses and/or product means, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1a schematically illustrates an example of an earpiece configured to be worn in an ear of a user.

FIG. 1b schematically illustrates an example of an earpiece configured to be worn in an ear of a user.

FIG. 1c schematically illustrates an example of an earpiece configured to be worn in an ear of a user.

FIG. 2a, FIG. 2b and FIG. 2c schematically illustrate examples of an earpiece configured to be worn in an ear of a user.

FIG. 3 is a graph showing the pressure response in an ear simulator for different venting setups.

FIG. 4 is a graph showing the occlusion response for different venting setups.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

Throughout, the same reference numerals are used for identical or corresponding parts.

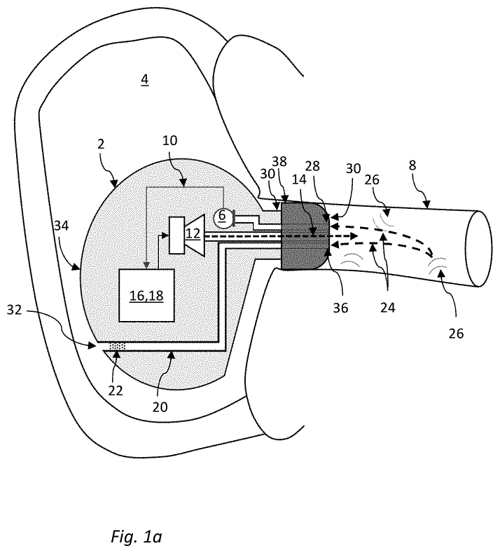

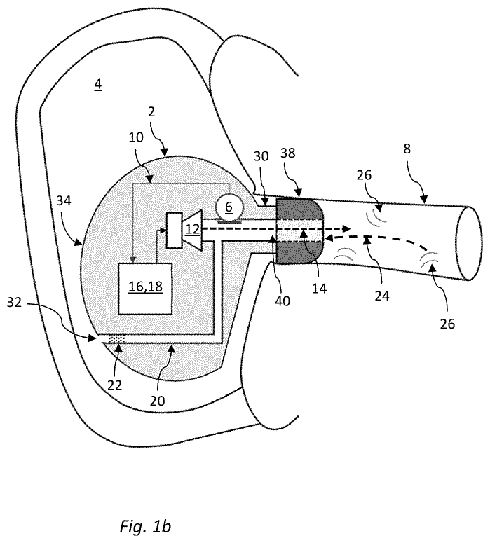

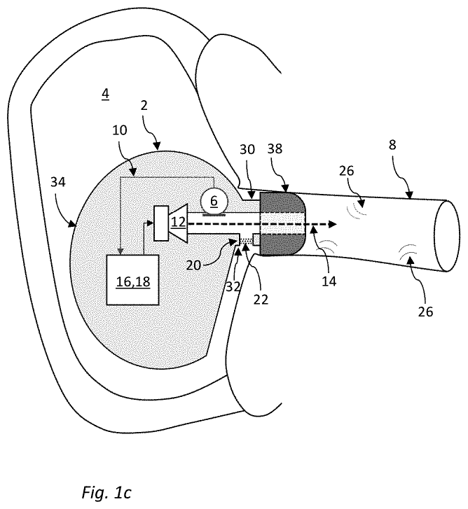

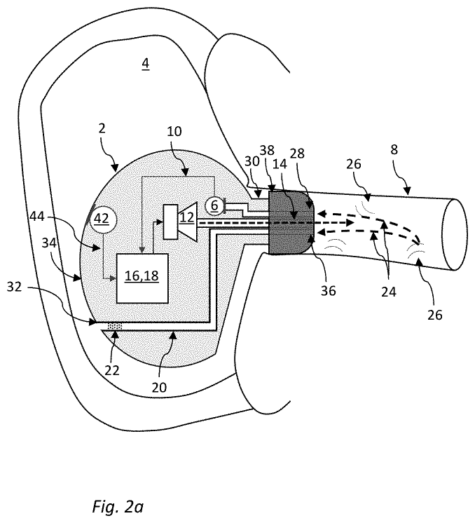

FIG. 1a schematically illustrates an example of an earpiece 2 configured to be worn in an ear 4 of a user. The earpiece 2 comprises a first input transducer 6 configured for receiving sound from the ear canal 8 of the user's ear 4. The first input transducer 6 is configured for providing a first input transducer signal 10. The earpiece 2 comprises an output transducer 12 configured for providing sound to the ear canal 8. The output transducer 12 is configured for providing an output transducer signal 14. The earpiece 2 comprises a processing unit 16 connected to the output transducer 12 and the first input transducer 6. The processing unit 16 comprises an active occlusion cancellation algorithm 18 configured to generate the output transducer signal 14 based on at least the first input transducer signal 10 for providing active occlusion cancellation. The earpiece 2 further comprises an acoustic filter configured for improving the active occlusion cancellation. The acoustic filter comprises a vent channel (20) for venting the ear canal (8) and is further configured as an acoustic high pass filter. The acoustic filter comprises an acoustic vent resonant cancelling filter (22) implemented in the vent channel. The acoustic filter being a resulting/combined acoustic filter comprising the vent channel (20) and further configured as an acoustic high pass filter and the acoustic vent resonant cancelling filter (22) implemented in the vent channel (20).

Sound pressure 24 can be generated in an occluded ear canal 8 due to own voice 26 as well as subsonic frequencies generated by jaw motion 26.

The first input transducer 6 may have a sound inlet 28 positioned at a first end 30, e.g. a tip portion of the earpiece 2, preferably allowing unhindered sensing of the ear canal sound pressure 24 within a fully or partly occluded ear canal 8 volume residing in front of the users tympanic membrane or eardrum.

The earpiece 2 has a second end 34 being opposite the first end 30, wherein the second end 34 is pointing towards the surroundings when the earpiece 2 is worn by the user.

The vent channel 20 has a first end 36 pointing towards the tympanic membrane in the ear canal 8 of the user and a second end 32 pointing towards the surroundings, when the earpiece 2 is worn in its intended operational position. The first end of the vent channel 20 may be positioned at the first end 30, e.g. the tip portion of the earpiece 2.

The vent channel 20 is configured to cause the main sound path to exhibit an acoustic high pass filter effect, i.e. as an open-ended side branch channel or side branch tube to a main sound path. Wherein the main sound path provides the output transducer signal 14 from the output transducer 12 to the eardrum of the user and/or the first input transducer 6. The properties of the acoustic high pass filter can be varied by configuring the size and/or shape of the vent channel 20. The acoustic vent resonant cancelling filter 22 may be arranged in or at the second end 32 of the vent channel 20. The acoustic vent resonant cancelling filter 22 may be arranged in a portion of the vent channel 20 being closer to the second end 32 than to the first end 36.

The second end 32 of the vent channel 20 is in the second end 34 of the earpiece 2.

A tip component 38 may be arranged at the first end 30 of the earpiece 2. The tip component 38 may be arranged at/attachable to a tip portion of the earpiece 2. The tip component may be dome shaped and may be made of foam or a flexible plastic material.

FIG. 1b schematically illustrates an example of an earpiece 2 configured to be worn in an ear 4 of a user. The earpiece 2 comprises a first input transducer 6 configured for receiving sound from the ear canal 8 of the user's ear 4. The first input transducer 6 is configured for providing a first input transducer signal 10. The earpiece 2 comprises an output transducer 12 configured for providing sound to the ear canal 8. The output transducer 12 is configured for providing an output transducer signal 14. The earpiece 2 comprises a processing unit 16 connected to the output transducer 12 and the first input transducer 6. The processing unit 16 comprises an active occlusion cancellation algorithm 18 configured to generate the output transducer signal 14 based on at least the first input transducer signal 10 for providing active occlusion cancellation. The earpiece 2 further comprises an acoustic filter configured for improving the active occlusion cancellation. The acoustic filter comprises a vent channel (20) for venting the ear canal (8) and is further configured as an acoustic high pass filter. The acoustic filter comprises an acoustic vent resonant cancelling filter (22) implemented in the vent channel (20). The acoustic filter being a resulting/combined acoustic filter comprising the vent channel (20) configured to cause the main sound path to exhibit an acoustic high pass filter effect and the acoustic vent resonant cancelling filter (22) implemented in the vent channel (20).

Sound pressure can be generated in an occluded ear canal 8 due to own voice 26 as well as subsonic frequencies generated by jaw motion 26.

The first input transducer 6 may have a sound inlet positioned at a first end 30, e.g. a tip portion of the earpiece 2, preferably allowing unhindered sensing of the ear canal sound pressure within a fully or partly occluded ear canal 8 volume residing in front of the users tympanic membrane or eardrum.

The earpiece 2 has a second end 34 being opposite the first end 30, wherein the second end 34 is pointing towards the surroundings when the earpiece 2 is worn by the user.

The vent channel 20 has a first end pointing towards the tympanic membrane in the ear canal 8 of the user and a second end 32 pointing towards the surroundings, when the earpiece 2 is worn in its intended operational position.

The vent channel 20 is configured to cause the main sound path to exhibit an acoustic high pass filter effect, i.e. consisting of an open-ended side branch channel or side branch tube to a main sound path. Wherein the main sound path provides the output transducer signal 14 from the output transducer 12 to the eardrum of the user and/or the first input transducer 6. The main sound path comprising an output sound channel in the earpiece 2 providing sound, such as the output transducer signal 14, to the ear canal 8. The open-ended side branch channel or side branch tube is provided in a sidewall of the output sound channel. The properties of the acoustic high pass filter can be varied by configuring the size and/or shape of the vent channel 20.

The acoustic vent resonant cancelling filter 22 may be arranged in or at the second end 32 of the vent channel 20. The acoustic vent resonant cancelling filter 22 may be arranged in a portion of the vent channel 20 being closer to the second end 32 than to the first end 36.

The second end 32 of the vent channel 20 is in the second end 34 of the earpiece 2.

The sound inlet of the first input transducer 6, the first end of the vent channel 20 and the outlet of the output transducer 12 may coincide in a first opening 40 of the earpiece 2. A tip component 38 may be arranged at the first opening 40 and/or the first end 30 of the earpiece 2. The tip component 38 may be arranged at/attachable to a tip portion of the earpiece 2. The tip component may be dome shaped and may be made of foam or a flexible plastic material.

FIG. 1c schematically illustrates an example of an earpiece 2 configured to be worn in an ear 4 of a user being similar to the earpiece of FIG. 1b. The difference being that the vent channel 20 is a short vent channel 20, for venting the ear canal 8.

The short vent channel 20 is configured to cause the main sound path to exhibit an acoustic high pass filter effect, i.e. consisting of an open-ended side branch channel or side branch tube to a main sound path. Wherein the main sound path provides the output transducer signal 14 from the output transducer 12 to the eardrum of the user and/or the first input transducer 6. The main sound path comprising an output sound channel in the earpiece 2 providing sound, such as the output transducer signal 14, to the ear canal 8. The open-ended side branch channel or side branch tube is provided in a sidewall of the output sound channel. The properties of the acoustic high pass filter can be varied by configuring the size and/or shape of the vent channel 20.

The short vent channel 20 comprises an acoustic vent resonant cancelling filter 22 configured for improving the active occlusion cancellation. The short vent channel 20 has a first end pointing towards the tympanic membrane in the ear canal 8 of the user and a second end 32 pointing towards the surroundings, when the earpiece 2 is worn in its intended operational position, i.e. the short vent channel 20 exits the earpiece 2 towards the surroundings in a side wall of the first end of the earpiece 2 and/or the tip portion of the earpiece 2. Thus, the second end 32 of the short vent channel 20 is in the first end 30 of the earpiece 2. The thickness of the side wall may correspond to/be the same as the length of the short vent channel 20. The thickness of the side wall and/or the length of the short vent channel 20 may be about 0.5-1 mm. The short vent channel in FIG. 1c could also be implemented in an earpiece similar to the earpiece in FIG. 1a.

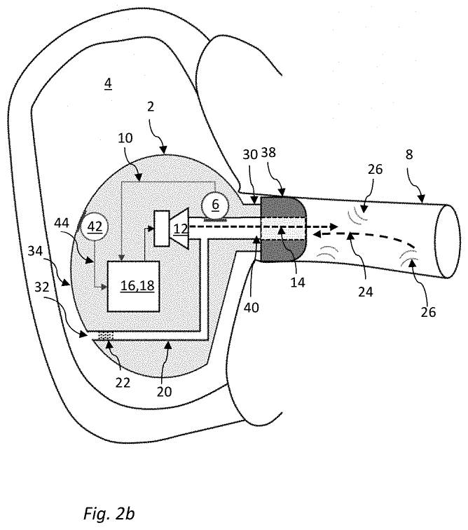

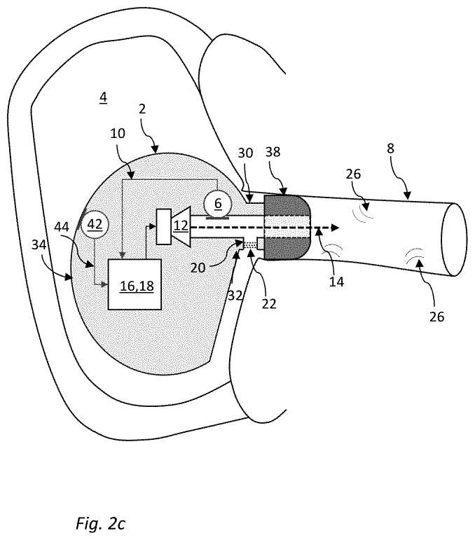

FIGS. 2a, 2b and 2c schematically illustrate examples of an earpiece 2 configured to be worn in an ear 4 of a user, wherein the earpiece is a hearing device, such as a hearing aid. The earpiece 2 comprises a first input transducer 6 configured for receiving sound from the ear canal 8 of the user's ear 4. The first input transducer 6 is configured for providing a first input transducer signal 10. The earpiece 2 comprises an output transducer 12 configured for providing sound to the ear canal 8. The output transducer 12 is configured for providing an output transducer signal 14. The earpiece 2 comprises a processing unit 16 connected to the output transducer 12 and the first input transducer 6. The processing unit 16 comprises an active occlusion cancellation algorithm 18 configured to generate the output transducer signal 14 based on at least the first input transducer signal 10 for providing active occlusion cancellation. The earpiece 2 further comprises an acoustic filter configured for improving the active occlusion cancellation. The acoustic filter comprises a vent channel (20) for venting the ear canal (8) and is further configured as an acoustic high pass filter. The acoustic filter comprises an acoustic vent resonant cancelling filter (22) implemented in the vent channel (20). The acoustic filter being a resulting/combined acoustic filter comprising the vent channel (20) configured to cause the main sound path to exhibit an acoustic high pass filter effect and the acoustic vent resonant cancelling filter (22) implemented in the vent channel (20).

The earpiece 2 further comprises a second input transducer 42 configured for receiving sound from the surroundings. The second input transducer 42 is configured for generating a second input transducer signal 44. The second input transducer 42 is connected to the processing unit 16 for providing the second input transducer signal 44 to the processing unit 16.

In FIG. 2a the vent channel 20 has a first end 36 pointing towards the tympanic membrane in the ear canal 8 of the user and a second end 32 pointing towards the surroundings, when the earpiece 2 is worn in its intended operational position. The first end of the vent channel 20 may be positioned at a first end 30, e.g. a tip portion of the earpiece 2.

The vent channel 20 is configured to cause the main sound path to exhibit an acoustic high pass filter effect, i.e. consisting of an open-ended side branch channel or side branch tube to a main sound path. Wherein the main sound path provides the output transducer signal 14 from the output transducer 12 to the eardrum of the user and/or the first input transducer 6. The properties of the acoustic high pass filter can be varied by configuring the size and/or shape of the vent channel 20.

The acoustic vent resonant cancelling filter 22 may be arranged in the second end 32 of the vent channel 20. The acoustic vent resonant cancelling filter 22 may be arranged in a portion of the vent channel 20 being closer to the second end 32 than to the first end 36.

The second end 32 of the vent channel 20 is in the second end 34 of the earpiece 2.

In FIG. 2b the vent channel 20 has a first end pointing towards the tympanic membrane in the ear canal 8 of the user and a second end 32 pointing towards the surroundings, when the earpiece 2 is worn in its intended operational position.

The vent channel 20 is configured to cause the main sound path to exhibit an acoustic high pass filter effect, i.e. consisting of an open-ended side branch channel or side branch tube to a main sound path. Wherein the main sound path provides the output transducer signal 14 from the output transducer 12 to the eardrum of the user and/or the first input transducer 6. The main sound path comprising an output sound channel in the earpiece 2 providing sound, such as the output transducer signal 14, to the ear canal 8. The open-ended side branch channel or side branch tube is provided in a sidewall of the output sound channel. The properties of the acoustic high pass filter can be varied by configuring the size and/or shape of the vent channel 20.

The acoustic vent resonant cancelling filter 22 may be arranged in the second end 32 of the vent channel 20. The acoustic vent resonant cancelling filter 22 may be arranged in a portion of the vent channel 20 being closer to the second end 32 than to the first end 36.

The second end 32 of the vent channel 20 is in the second end of the earpiece 2.

The sound inlet of the first input transducer 6, the first end of the vent channel 20 and the outlet of the output transducer 12 may coincide in a first opening 40 of the earpiece 2. A tip component 38 may be arranged at the first opening 40 and/or the first end of the earpiece 2. The tip component 38 may be arranged at/attachable to a tip portion of the earpiece 2. The tip component may be dome shaped and may be made of foam or a flexible plastic material.

FIG. 2c schematically illustrates an example of an earpiece 2 configured to be worn in an ear 4 of a user being similar to the earpiece of FIG. 2b. The difference being that the vent channel 20 is a short vent channel 20, for venting the ear canal 8.

The short vent channel 20 is configured to cause the main sound path to exhibit an acoustic high pass filter effect, i.e. consisting of an open-ended side branch channel or side branch tube to a main sound path. Wherein the main sound path provides the output transducer signal 14 from the output transducer 12 to the eardrum of the user and/or the first input transducer 6. The main sound path comprising an output sound channel in the earpiece 2 providing sound, such as the output transducer signal 14, to the ear canal 8. The open-ended side branch channel or side branch tube is provided in a sidewall of the output sound channel. The properties of the acoustic high pass filter can be varied by configuring the size and/or shape of the vent channel 20.

The short vent channel 20 comprises an acoustic vent resonant cancelling filter 22 configured for improving the active occlusion cancellation. The short vent channel 20 has a first end pointing towards the tympanic membrane in the ear canal 8 of the user and a second end 32 pointing towards the surroundings, when the earpiece 2 is worn in its intended operational position, i.e. the short vent channel 20 exits the earpiece 2 towards the surroundings in a side wall of the first end 30 of the earpiece 2 and/or the tip portion of the earpiece 2. Thus, the second end 32 of the short vent channel 20 is in the first end 30 of the earpiece 2. The thickness of the side wall may correspond to/be the same as the length of the short vent channel 20. The thickness of the side wall and/or the length of the short vent channel 20 may be about 0.5-1 mm. The short vent channel 20 in FIG. 2c could also be implemented in an earpiece 2 similar to the earpiece in FIG. 2a.

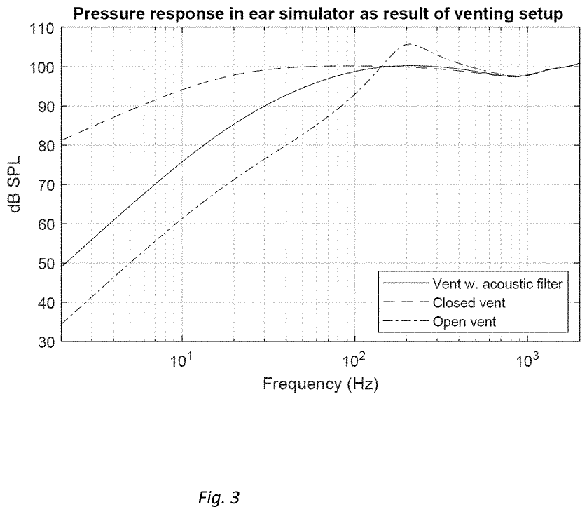

FIG. 3 is a graph showing the pressure response in an ear simulator for different venting setups. Sound pressure level (SPL) measured in dB is shown on the y-axis as a function/result of frequency measured in Hz shown on the x-axis. Three different venting setups are shown: A closed vent (shown in even dashed line) corresponding to having no vent in the earpiece. An open vent (shown in uneven dashed line) corresponding to having a vent in the earpiece. A vent with an acoustic vent resonant cancelling filter (shown in full line) corresponding to the earpiece of the present disclosure.

FIG. 3, see graph of “closed vent” (shown in even dashed line) corresponding to having no vent in the earpiece, shows that very high sound pressure levels (SPL) can be generated in an occluded ear canal due to own voice as well as subsonic frequencies generated by jaw motion. Subsonic levels may reach as high as 143 dB SPL at 2 Hz in an occluded ear canal. This is an important consideration when dealing with Active Occlusion Cancelation (AOC) because such high low frequency output levels could overdrive the output transducer (receiver) and/or saturate the first input transducer (ear canal microphone).

FIG. 3, see graph of “open vent” (shown in uneven dashed line) corresponding to having a vent, such as a vent channel, in the earpiece, shows that a 1 mm vent (of 2 cm length) may reduce the energy level of own voice and/or subsonic frequencies considerably such that they may be managed, but even so they may remain high (˜98 dB).

However, the usefulness of having a vent comes at a cost as it increases the amount of audible occlusion due to the introduction of a vent resonance at 150-350 Hz. Furthermore, the aggressive roll-off after the vent resonance spans across the active occlusion cancellation (AOC) range of a typical active occlusion cancellation (AOC) algorithm, which inflicts greatly on the performance of the typical AOC algorithm due to drastic changes in phase that the typical AOC algorithm cannot handle.

FIG. 3, see graph of “vent with acoustic filter” (shown in full line) corresponding to the earpiece of the present disclosure, shows an embodiment solving the problems that the vent introduces, while keeping the benefits of the vent. The present embodiment solves the problem by insertion of an acoustic vent resonant cancelling filter, such as a foam material, in the vent to increase the acoustic mass/resistance of the vent. This may provide the same effect as making the vent drastically longer and/or narrower, but without the size penalty that comes with these corrections, which is perfect for small earpieces or in-the-ear hearing devices.

FIG. 3, see graph of “vent with acoustic filter” (shown in full line) corresponding to the earpiece of the present disclosure having a vent channel with an acoustic vent resonant cancelling filter, shows that if simulating the frequency response of an earpiece, it can be seen how the acoustic filter smoothens the vent resonance and pushes the low-frequency roll off closer to the 80-100 Hz target that may be required in order to avoid drastic phase changes in the AOC range, which is between 80-600 Hz, while still providing a noticeable roll-off toward low frequencies to avoid high own voice and/or subsonic energy levels. As an example of a simulated earpiece, the vent of the simulated device may be 22 mm long and 0.8 mm in diameter, with an acoustic vent resonant cancelling filter being a mesh filter of 60 Rayls (Pa*s/m).

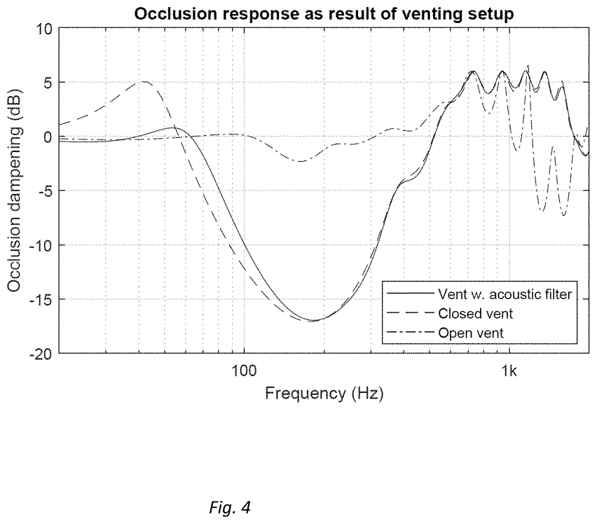

FIG. 4 is a graph showing the occlusion response for different venting setups. Occlusion dampening measured in dB is shown on the y-axis as a function/result of frequency measured in Hz shown on the x-axis. Three different venting setups are shown: A closed vent (shown in even dashed line) corresponding to having no vent in the earpiece. An open vent (shown in uneven dashed line) corresponding to having a vent channel in the earpiece. A vent with acoustic filter (shown in full line) corresponding to the earpiece of the present disclosure having a vent channel with an acoustic vent resonant cancelling filter.

FIG. 4, see graph of “open vent” (shown in uneven dashed line) corresponding to having a vent, such as a vent channel, in the earpiece, shows that when simulating active occlusion cancellation (AOC) performance in an earpiece, the vented device without the acoustic vent resonant cancelling filter may only give a reduction in occlusion of few dBs, such as 2-4 dB or about 3 dB at 145-160 Hz, such as about 150 Hz, and may yield a very narrow bandwidth of dampening.

FIG. 4, see graph of “vent with acoustic filter” (shown in full line) corresponding to the earpiece of the present disclosure having a vent channel with an acoustic vent resonant cancelling filter, shows that by introducing the acoustic vent resonant cancelling filter in the vent, the simulated AOC performance may reach +15 dB dampening, which is equal to or approximately equal to the unvented configuration (see graph of “closed vent” (shown in even dashed line) corresponding to having no vent in the earpiece) and which may have a very wide bandwidth that is almost identical to the unvented earpiece.

Thus, a vent, such as a vent channel, may be necessary for a typical active occlusion cancelling (AOC) algorithm to work in all conditions, however it comes at the cost of lost performance (see graph of “open vent” (shown in uneven dashed line) corresponding to having a vent in the earpiece).

Thus, FIG. 4, see graph of “vent with acoustic filter” (shown in full line) corresponding to the earpiece of the present disclosure having a vent channel with an acoustic vent resonant cancelling filter, shows that it is an advantage of the present earpiece/hearing device/hearing protection/hearing aid that the vent channel with the acoustic vent resonant cancelling filter results in a good AOC performance like that of an unvented device, while still maintaining the necessary properties of the vent for the AOC algorithm and/or AOC system to work properly.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### Items

1. An earpiece configured to be worn in an ear of a user, the earpiece comprising:

a first input transducer configured for receiving sound from the ear canal of the user's ear, the first input transducer being configured for providing a first input transducer signal;
an output transducer configured for providing sound to the ear canal, the output transducer being configured for providing an output transducer signal;
a processing unit connected to the output transducer and the first input transducer, the processing unit comprises an active occlusion cancellation algorithm configured to generate the output transducer signal based on at least the first input transducer signal for providing active occlusion cancellation;
wherein the earpiece further comprises:
an acoustic filter configured for improving the active occlusion cancellation, the acoustic filter comprising:
a vent channel for venting the ear canal and configured to cause the main sound path to exhibit an acoustic high pass filter effect, and
an acoustic vent resonant cancelling filter implemented in the vent channel.

2. The earpiece according to item 1, wherein the acoustic vent resonant cancelling filter is configured for providing an increased acoustic resistance of the vent channel.

3. The earpiece according to any of the preceding items, wherein the acoustic filter is configured for optimizing the output transducer signal generated by the active occlusion cancellation algorithm.

4. The earpiece according to any of the preceding items, wherein the vent channel provides reduction of the subsonic/low-frequency sound pressure levels in the ear canal of the user.

5. The earpiece according to any of the preceding items, wherein the acoustic vent resonant cancelling filter provides a changed/smoothed frequency response of the vent channel.

6. The earpiece according to any of the preceding items, wherein the acoustic vent resonant cancelling filter is a physical/mechanical filter.

7. The earpiece according to any of the preceding items, wherein the acoustic vent resonant cancelling filter is made of foam, mesh, cloth, textile, fabric, and/or metal.

8. The earpiece according to any of the preceding items, wherein the acoustic vent resonant cancelling filter comprises/is defined by an acoustic impedance value.

9. The earpiece according to any of the preceding items, wherein the acoustic vent resonant cancelling filter has an acoustic impedance value in the range of 10-500 Rayls (Pa*s/m), such as 60 Rayls (Pa*s/m).

10. The earpiece according to any of the preceding items, wherein the acoustic vent resonant cancelling filter comprises/is defined by a surface size and/or a density.

11. The earpiece according to any of the preceding items, wherein the vent channel has a first end pointing towards the tympanic membrane in the ear of the user and a second end pointing towards the surroundings, when the earpiece is worn in its intended operational position, and wherein the acoustic vent resonant cancelling filter is arranged in the second end of the vent channel.

12. The earpiece according to any of the preceding items, wherein the acoustic vent resonant cancelling filter is further configured for providing protection against water and dirt.

13. The earpiece according to any of the preceding items, wherein the acoustic vent resonant cancelling filter is arranged in a frame, and wherein the frame is configured to be pushed/slid into the vent channel for fixation of the acoustic vent resonant cancelling filter in the vent channel.

14. The earpiece according to any of the preceding items, wherein the earpiece forms part of a hearing device.

15. The earpiece according to any of the preceding items, wherein the earpiece further comprises a second input transducer configured for receiving sound from the surroundings, wherein the second input transducer is connected to the processing unit.

16. The earpiece according to any of the preceding items, wherein the earpiece is for a hearing aid configured to compensate for a hearing loss of the user.

17. The earpiece according to any of the preceding items, wherein the earpiece is for a headset configured for transmission of audio to the user's ear.

18. A system for an earpiece, the earpiece being configured to be worn in an ear of a user, the system comprising:

a first input transducer configured for receiving sound from the ear canal of the user's ear, the first input transducer being configured for providing a first input transducer signal;
an output transducer configured for providing sound to the ear canal, the output transducer being configured for providing an output transducer signal;
a processing unit connected to the output transducer and the first input transducer, the processing unit comprises an active occlusion cancellation algorithm configured to generate the output transducer signal based on at least the first input transducer signal for providing active occlusion cancellation;
wherein the system further comprises:
an acoustic filter configured for improving the active occlusion cancellation, the acoustic filter comprising:
a vent channel for venting the ear canal and configured to cause the main sound path to exhibit an acoustic high pass filter effect, and
an acoustic vent resonant cancelling filter implemented in the vent channel.

### LIST OF REFERENCES

2 earpiece

4 ear

6 first input transducer

8 ear canal

10 first input transducer signal

12 output transducer

14 output transducer signal

16 processing unit

18 active occlusion cancellation algorithm

20 vent channel

22 acoustic vent resonant cancelling filter

24 sound pressure

26 own voice, jaw motion, subsonic frequencies generated by jaw motion

28 sound inlet

30 first end of earpiece

32 second end of the vent channel

34 second end of earpiece

36 first end of vent channel

38 tip component

40 first opening of earpiece

42 second input transducer

44 second input transducer signal

1. An earpiece configured to be worn in an ear of a user, the earpiece comprising:
a first input transducer configured to receive sound from an ear canal of the user, the first input transducer being configured to provide a first input transducer signal;
an output transducer configured to provide output sound to the ear canal;
a processing unit connected to the output transducer and the first input transducer, the processing unit comprising an active occlusion cancellation algorithm configured to generate an output signal based on at least the first input transducer signal for providing active occlusion cancellation;
a vent channel for venting the ear canal; and
an acoustic vent resonance cancelling filter in the vent channel.

2. The earpiece according to claim 1, wherein the vent channel and the acoustic vent resonance cancelling filter are configured to improve the active occlusion cancellation.

3. The earpiece according to claim 1, wherein the vent channel and the acoustic vent resonance cancelling filter together form an acoustic filter.

4. The earpiece according to claim 3, wherein the acoustic filter is configured to improve or optimize the output signal generated by the active occlusion cancellation algorithm.

5. The earpiece according to claim 1, wherein the acoustic vent resonance cancelling filter is configured to provide an increased acoustic resistance for the vent channel.

6. The earpiece according to claim 1, wherein the vent channel is configured to provide a reduction of a subsonic sound pressure level in the ear canal of the user.

7. The earpiece according to claim 1, wherein the vent channel is configured to provide a reduction of a low-frequency sound pressure level in the ear canal of the user.

8. The earpiece according to claim 1, wherein the acoustic vent resonance cancelling filter is configured to affect a frequency response associated with the vent channel.

9. The earpiece according to claim 1, wherein the acoustic vent resonance cancelling filter is configured to cancel or suppress or annul a resonance associated with the vent channel.

10. The earpiece according to claim 1, wherein the acoustic vent resonance cancelling filter is configured to smoothen a resonance associated with the vent channel.

11. The earpiece according to claim 1, wherein the acoustic vent resonance cancelling filter is a physical filter.

12. The earpiece according to claim 1, wherein the acoustic vent resonance cancelling filter comprises an acoustic impedance value

13. The earpiece according to claim 1, wherein the acoustic vent resonance cancelling filter is associated with an acoustic impedance value.

14. The earpiece according to claim 1, wherein the acoustic vent resonance cancelling filter comprises a surface size and/or a density.

15. The earpiece according to claim 1, wherein the earpiece is for a hearing aid configured to compensate for a hearing loss of the user.

16. The earpiece according to claim 1, wherein the acoustic vent resonance cancelling filter is configured to push a low-frequency roll off below a 80-100 Hz target.

17. A system for an earpiece, the earpiece being configured to be worn in an ear of a user, the system comprising:
a first input transducer configured to receive sound from an ear canal of the user, the first input transducer being configured to provide a first input transducer signal;
an output transducer configured to provide output sound to the ear canal;
a processing unit connected to the output transducer and the first input transducer, the processing unit comprising an active occlusion cancellation algorithm configured to generate an output signal based on at least the first input transducer signal for providing active occlusion cancellation;
a vent channel for venting the ear canal; and
an acoustic vent resonance cancelling filter in the vent channel.
